(19) United States
(12) Patent Application Publication
(10) Pub. No.: US 2024/0195587 A1
(43) Pub. Date: Jun. 13, 2024

(54) METHODS AND APPARATUSES FOR USE IN SPECTRUM SHARING

(71) Applicant: Telefonaktiebolaget LM Ericsson (publ), Stockholm (SE)

(72) Inventor: Saad Naveed AHMED, Sundbyberg (SE)

(21) Appl. No.: 18/556,162

(22) PCT Filed: Apr. 20, 2021
(86) PCT No.: PCT/SE2021/050359

§ 371 Date: Oct. 19, 2023

(51) Int. Cl. H04L 5/00; H04W 16/14

(52) U.S. Cl. CPC H04L 5/0073; H04L 5/005; H04W 16/14

(57) ABSTRACT

Embodiments described herein relate to methods and apparatuses for a New Radio base station that is spectrum sharing with a Long Term Evolution base station. A method in a first scheduler for use in a New Radio base station includes determining that one or more NR messages are to be scheduled for transmission during a time period, wherein the one or more NR messages cannot perform LTE Cell Specific Reference Signal, CRS, rate matching; and responsive to the determination, transmitting a first indication that there are one or more NR messages that cannot perform LTE CRS rate matching to be transmitted during the time period to a shared resource allocator configured to allocate resources to the NR base station and the LTE base station.

### TECHNICAL FIELD

Embodiments described herein provide methods and apparatuses for use in a New Radio (NR) base station and a Long Term Evolution (LTE) base station that are spectrum sharing. In particular, embodiments described herein avoid collisions between NR Messages that cannot perform LTE Cell Specific Reference Signal (CRS) rate matching, and LTE CRS.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

5G will be introduced on both new and legacy spectrum bands. This requires functionality that enables operators to plan the evolution of 5G of network assets including both spectrum bands and technologies, as well as, functionality that allows for a seamless roll-out of 5G with optimal end-user performance. Spectrum Sharing, as illustrated in FIG. 1, provides the possibility to intelligently, flexibly and quickly introduce and add 5G within existing 4G carriers, e.g. to introduce 5G on low/mid bands for wide area coverage and outside in coverage. Spectrum Sharing software may dynamically share spectrum between 4G and 5G carriers based on traffic demand. The switch between carriers may happen within milliseconds, which minimizes spectrum wastage and allows for best end-user performance.

FIG. 2 illustrates various New Radio (NR) messages. Most NR Physical Downlink Shared Channel (PDSCH) (e.g. those transmitting after RRC Reconfiguration) may use Cell Specific Reference Signal (CRS) rate matching to avoid interference from LTE's CRS. However, as illustrated in FIG. 2, there are certain NR messages which cannot do such rate matching. Examples of messages that cannot perform CRS rate matching are random access and paging messages. For example, Msg2, Msg4, a Security Mode message, a UE Capability Enquiry and an RRC Reconfiguration may be unable to perform CRS rate matching. The reason that these messages cannot perform CRS rate matching may be that the UE capability of rate matching is not configured until after the UE capability message is received, or UE is in an idle state and therefore cannot rate match. These messages may experience interference from the LTE-CRS. This problem may be exacerbated if LTE CRS gain is used.

FIG. 3 illustrates an LTE CRS pattern for port index 0 of 4 CRS Port. In this pattern, the dotted squares are LTE CRS resource elements (RE) that are transmitted in 1^{st}, 5^{th}, 8^{th} and 12^{th} symbols. CRS in 5^{th}, 8^{th} and 12^{th} symbols may interfere with NR messages that cannot do CRS rate matching around these CRS REs.

In existing solutions, the NR codeword is first written as if no RE is reserved, then the NR data corresponding to the reserved REs is emptied out. This creates loss of data in the CRS REs. The CRS REs may also act as interference towards these REs further creating decoding issues for the UE.

Existing solutions use a lowest possible modulation and coding scheme to counter LTE interference. However, using a lowest possible modulation and coding scheme still results in a 1.5 dB gap to no CRS interference, as illustrated in FIGS. 4 and 5.

In FIG. 4 the lines represent Msg2. The dotted line is Signal-to-Noise ratio (SNR) vs Block Error Rate (BLER) when there is no CRS interference and solid line is with CRS interference.

In FIG. 5 the lines represent Msg4. The dotted line is Signal-to-Noise ratio (SNR) vs Block Error Rate (BLER) when there is no CRS interference and solid line is with CRS interference. As can be seen in both FIG. 4 and FIG. 5, for both Msg2 and Msg4 there is SNR difference of around 1.5 dB for 10% BLER. For Msg4 there is also a significant increase in PRBs needed to carry the same payload.

This solution also consumes more Physical Resource Blocks (PRBs) than without CRS interference. The performance in real world deployment is even worse if LTE-CRS are power boosted.

### SUMMARY

According to some embodiments there is provided a method in first scheduler for use in a New Radio base station that is spectrum sharing with a Long Term Evolution, LTE, base station. The method comprises determining that one or more NR messages are to be scheduled for transmission during a time period, wherein the one or more NR messages cannot perform LTE Cell Specific Reference Signal, CRS, rate matching; and
responsive to the determination, transmitting a first indication that there are one or more NR messages that cannot perform LTE CRS rate matching to be transmitted during the time period to a shared resource allocator configured to allocate resources to the NR base station and the LTE base station.

According to some embodiments there is provided a method in a second scheduler for use in a Long Term Evolution base station that is spectrum sharing with a New Radio, NR, base station. The method comprises receiving a first indication that there are one or more NR messages to be transmitted by the NR base station during a time period that cannot perform LTE Cell Specific Reference Signal, CRS, rate matching; and responsive to receiving the indication, instructing a DL transmitter in the LTE base station to mute CRS on one or more resources during the time period.

According to some embodiments there is provided a method in a shared resource allocator configured to allocate shared resources to a Long Term Evolution base station and a New Radio, NR, base station that are spectrum sharing. The method comprises receiving a first indication, from the NR base station, that one or more NR messages to be scheduled for transmission during a time period cannot perform LTE CRS rate matching; and responsive to receiving the first indication from the NR base station, transmitting a second indication, to the LTE base station, that there are one or more NR messages to be scheduled for transmission during the time period that cannot perform LTE CRS rate matching.

According to some embodiments there is provided a first scheduler for use in a New Radio base station that is spectrum sharing with a Long Term Evolution, LTE, base station. The first scheduler comprises processing circuitry configured to: determine that one or more NR messages are to be scheduled for transmission during a time period, wherein the one or more NR messages cannot perform LTE Cell Specific Reference Signal, CRS, rate matching; and responsive to the determination, transmit a first indication that there are one or more NR messages that cannot perform LTE CRS rate matching to be transmitted during the time period to a shared resource allocator configured to allocate resources to the NR base station and the LTE base station.

According to some embodiments there is provided a second scheduler for use in a Long Term Evolution base station that is spectrum sharing with a New Radio, NR, base station. The second scheduler comprises processing circuitry configured to: receive a first indication that there are one or more NR messages to be transmitted by the NR base station during a time period that cannot perform LTE Cell Specific Reference Signal, CRS, rate matching; and responsive to receiving the indication, instruct a DL transmitter in the LTE base station to mute CRS on one or more resources during the time period.

According to some embodiments there is provided a shared resource allocator configured to allocate shared resources to a Long Term Evolution base station and a New Radio, NR, base station that are spectrum sharing. The shared resource allocator comprises processing circuitry configured to: receive a first indication, from the NR base station, that one or more NR messages to be scheduled for transmission during a time period cannot perform LTE CRS rate matching; and responsive to receiving the first indication from the NR base station, transmit a second indication, to the LTE base station, that there are one or more NR messages to be scheduled for transmission during the time period that cannot perform LTE CRS rate matching.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates Spectrum Sharing;

FIG. 2 illustrates various New Radio (NR) messages;

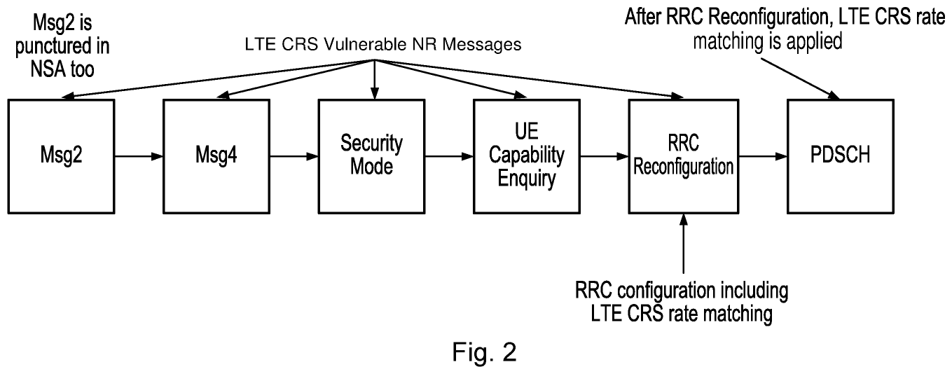

FIG. 3 illustrates an LTE CRS pattern for port index 0 of 4 CRS Port;

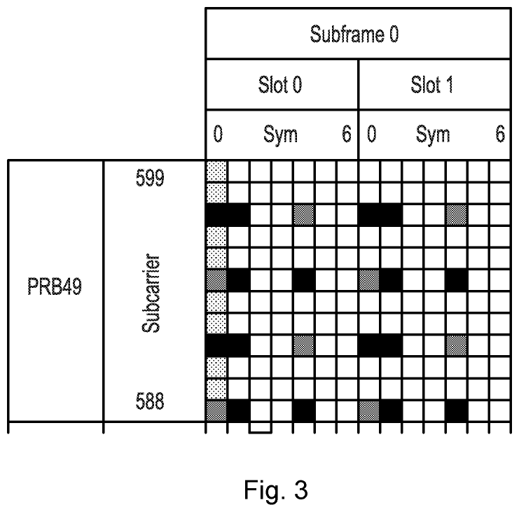

FIG. 4 illustrates how using a lowest possible modulation and coding scheme still results in a 1.5 dB gap to no CRS interference;

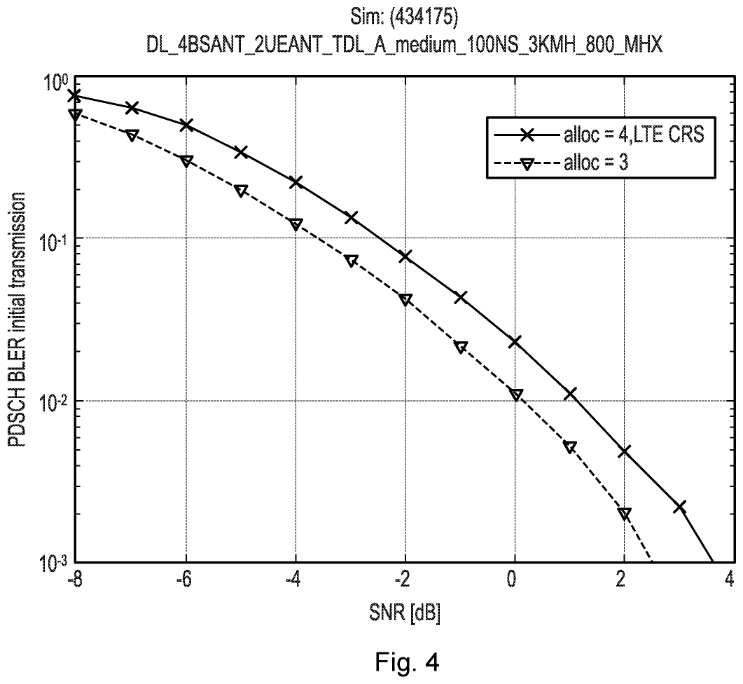

FIG. 5 illustrates how using a lowest possible modulation and coding scheme still results in a 1.5 dB gap to no CRS interference;

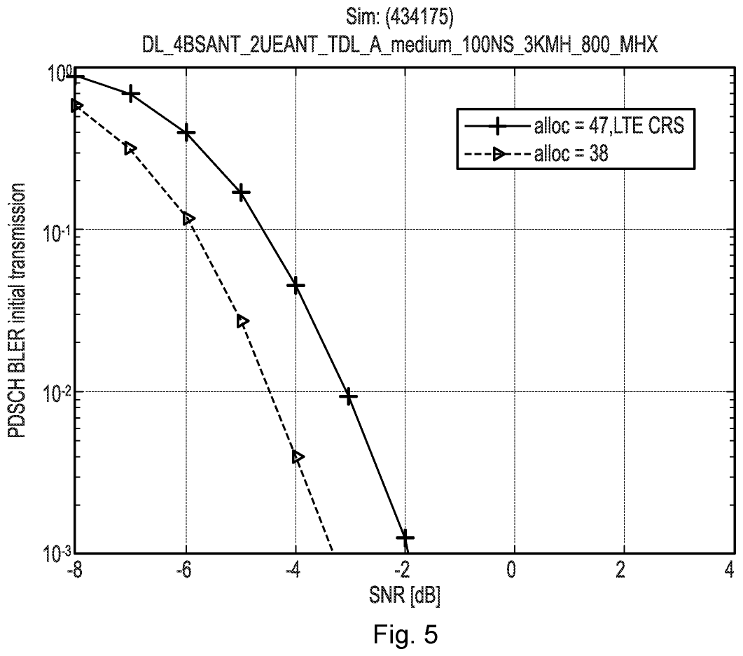

FIG. 6 illustrates a spectrum sharing system according to some embodiments;

FIG. 7 illustrates a method in first scheduler for use in a New Radio base station that is spectrum sharing with a Long Term Evolution, LTE, base station;

FIG. 8 illustrates a method in a second scheduler for use in a Long Term Evolution base station that is spectrum sharing with a New Radio, NR, base station;

FIG. 9 illustrates a method in shared resource allocator configured to allocate shared resources to a Long Term Evolution base station and a New Radio, NR, base station that are spectrum sharing;

FIG. 10 is a flow chart illustrating an example implementation of the methods of FIGS. 7 to 9;

FIG. 11 illustrates a first scheduler 1100 comprising processing circuitry (or logic);

FIG. 12 illustrates a second scheduler 1200 comprising processing circuitry (or logic);

FIG. 13 illustrates a shared resource allocator 1300 comprising processing circuitry (or logic).

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments described herein provide methods and apparatuses to remove LTE-CRS interference in a multi Radio Access Technology (RAT) system of shared spectrum. Embodiments described herein also increase reliability of CRS vulnerable NR messages.

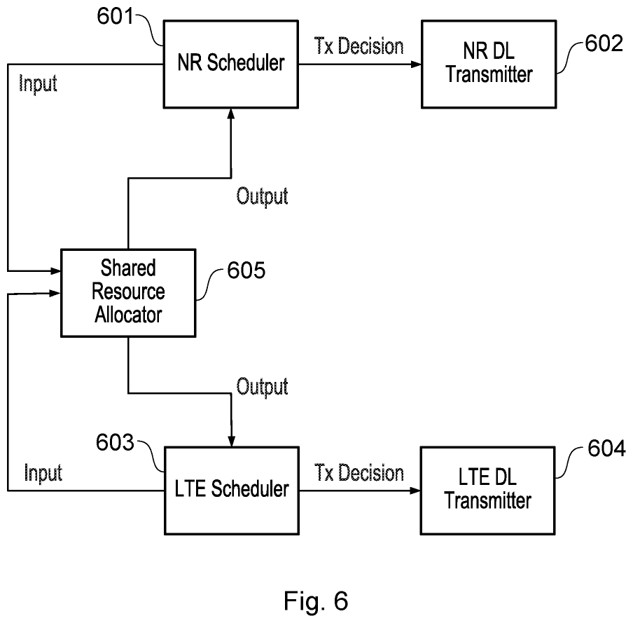

FIG. 6 illustrates a spectrum sharing system according to some embodiments. The spectrum sharing system 600 comprises an NR scheduler 601 and an NR Downlink (DL) transmitter 602. The NR scheduler 601 and the NR DL transmitter 602 may form part of an NR base station.

The spectrum sharing system 600 further comprises an LTE scheduler 603 and an LTE Downlink (DL) transmitter 604. The LTE scheduler 603 and the LTE DL transmitter 604 may form part of an LTE base station.

The spectrum sharing system 600 further comprises a shared resource allocator 605. The shared resource allocator 605 may be configured to allocate resources to the LTE scheduler 603 and the NR scheduler 601.

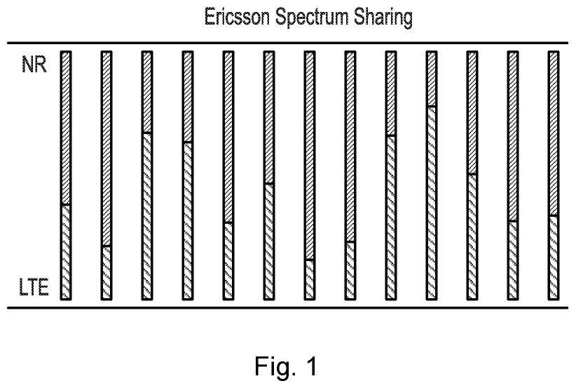

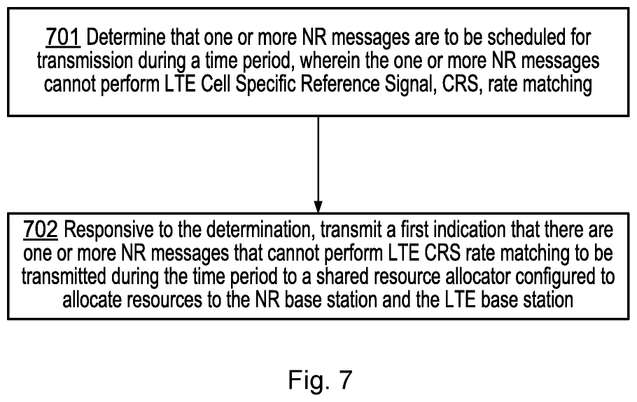

FIG. 7 illustrates a method in first scheduler for use in a New Radio base station that is spectrum sharing with a Long Term Evolution, LTE, base station. The first scheduler may comprise the NR scheduler 601 illustrated in FIG. 1.

In step 701, the first scheduler determines that one or more NR messages are to be scheduled for transmission during a time period, wherein the one or more NR messages cannot perform LTE Cell Specific Reference Signal, CRS, rate matching. The time period may for example comprise a transmission time interval.

The one or more NR messages may comprise one or more of: a message to be transmitted during a random access procedure, a paging message and a message (e.g. a system information message) to be transmitted whilst a wireless device is in an idle state.

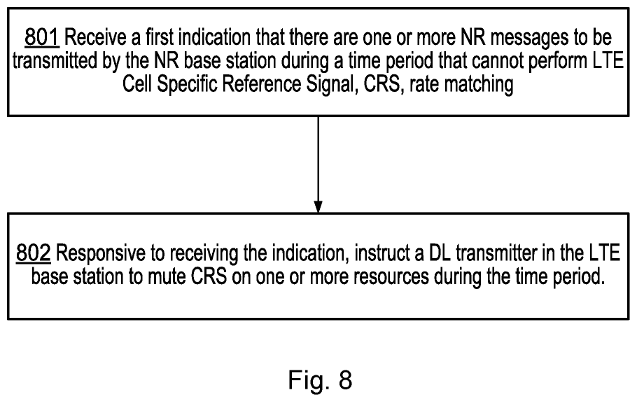

In step 702, the first scheduler, responsive to the determination in step 701, transmits a first indication that there are one or more NR messages that cannot perform LTE CRS rate matching to be transmitted during the time period to a shared resource allocator configured to allocate resources to the NR base station and the LTE base station. The the first indication is for use in the LTE base station to mute CRS on one or more resources during the time period, as will be described in more detail with reference to FIG. 8. The first indication may be transmitted to a shared resource allocator.

In some embodiments the method further comprises receiving a second indication of one or more resources to be used by the NR base station to transmit the one or more NR messages. The one or more resources may comprise one or more of: Physical Downlink Control Channel and/or Physical Downlink Shared Channel physical resource blocks or resource block groups. The method may then further comprise transmitting the one or more NR messages using the one or more resources.

FIG. 8 illustrates a method in a second scheduler for use in a Long Term Evolution base station that is spectrum sharing with a New Radio, NR, base station. The second scheduler may comprise the LTE scheduler 603 as illustrated in FIG. 6.

In step 801 the second scheduler receives a first indication that there are one or more NR messages to be transmitted by the NR base station during a time period that cannot perform LTE Cell Specific Reference Signal, CRS, rate matching. The first indication may be received from a shared resource allocator. The time period may, for example, comprise a transmission time interval.

The one or more NR messages may comprise one or more of: a message to be transmitted during a random access procedure, a paging message and a message to be transmitted whilst a wireless device is in an idle state.

In step 802, responsive to receiving the indication, the second scheduler instructs a DL transmitter in the LTE base station to mute CRS on one or more resources during the time period. This muting avoids interference between the CRS and the one or more NR messages.

In some examples, the one or more resources comprises all resources allocated to the NR base station during the time period. This may, for example, be performed when the LTE base station is unaware of which resources during the time period will be used for the one or more NR messages.

In some examples however, the second scheduler may receive a second indication of one or more resources from, for example, the shared resource allocator. The one or more resources may comprise one or more resources allocated to the one or more messages.

In some examples, the method may further comprise instructing the DL transmitter in the LTE base station to boost power on transmission of one or more other CRSs transmitted during the time interval. In other words, to compensate for muting CRS during the time period to avoid interference with the one or more NR messages, the power may be boosted on other CRS during the time period.

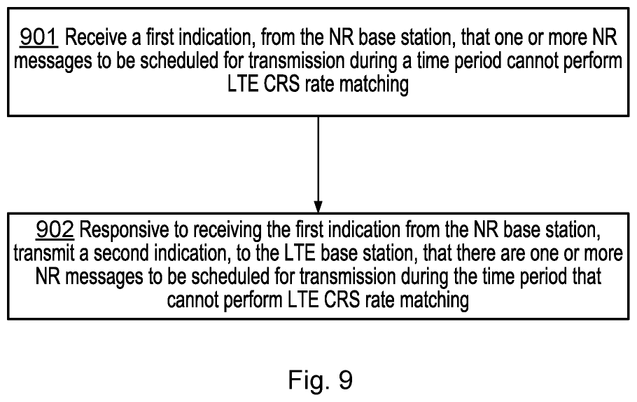

FIG. 9 illustrates a method in shared resource allocator configured to allocate shared resources to a Long Term Evolution base station and a New Radio, NR, base station that are spectrum sharing. The shared resource allocator may comprise the shared resource allocator 605 as illustrated in FIG. 6.

In step 901, the shared resource allocator receives a first indication, from the NR base station, that one or more NR messages to be scheduled for transmission during a time period cannot perform LTE CRS rate matching. The time period may, for example, comprise a transmission time interval.

As previously described, the one or more NR messages may comprise one or more of: a message to be transmitted during a random access procedure, a paging message and a message to be transmitted whilst a wireless device is in an idle state.

In step 902, responsive to receiving the first indication from the NR base station, the shared resource allocator transmitting a second indication, to the LTE base station, that there are one or more NR messages to be scheduled for transmission during the time period that cannot perform LTE CRS rate matching.

In some embodiments, the shared resource allocator may also transmit a third indication to the LTE base station of one or more resources to be used by the NR base station to transmit the one or more NR messages. The one or more resources may comprise one or more of: PDCCH/PDSCH physical resource blocks or resource block groups.

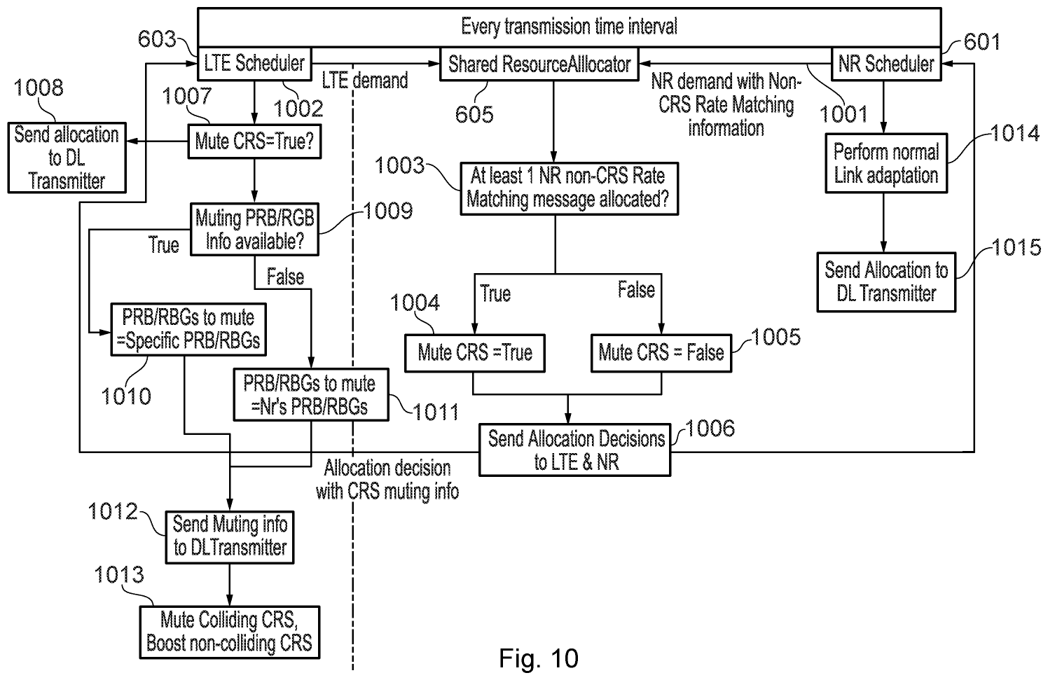

FIG. 10 is a flow chart illustrating an example implementation of the methods of FIGS. 7 to 9.

In step 1001 the NR scheduler transmits an NR demand to the shared resource allocator 605. The NR demand comprises an indication of the one or more NR messages to be scheduled for transmission during a time period (e.g. the current TTI) that cannot perform LTE CRS rate matching.

In step 1002, the LTE scheduler 603 transmits an LTE demand to the shared resource allocator 605. The LTE demand comprises an indication of CRS scheduled to be transmitted by the LTE base station during the time period.

In step 1003, the shared resource allocator determines whether at least one NR message has been scheduled for transmission that cannot perform CRS rate matching.

If in step 1003, the shared resource allocator 605 determined that at least one NR message has been scheduled for transmission that cannot perform rate matching, the method passes to step 1004 in which the shared resource allocator 605 sets a CRS muting parameter to true.

If in step 1003, the shared resource allocator 605 determines that no NR message has been scheduled for transmission during the time period that cannot perform rate matching, the method passes to step 1005 in which the shared resource allocator 605 sets a CRS muting parameter to false.

In step 1006 the shared resource allocator 605 assigns necessary resources (e.g. PDCCH, PDSCH PRBs/RBGs) to the NR and LTE demands and transmits resource allocation decisions to the LTE base station and to the NR base station. The resource allocation decision to the LTE base station comprises the CRS muting parameter. In some examples, the resource allocation decision transmitted to the LTE base station comprises an indication of one or more resources (e.g. PRBs/RBGs) to be used by the NR base station to transmit the one or more NR messages that cannot perform CRS rate matching.

In step 1007 the LTE scheduler determines whether the CRS muting parameter is set to true or false. If the CRS muting parameter is set to false, the LTE scheduler sends the allocation decision to the LTE DL transmitter in step 1008 without performing any CRS muting.

If the CRS muting parameter is set to true, the method passes to step 1009. In step 1009, the LTE scheduler 603 determines if any information is available relating to the resources to be used by NR base station to transmit the one or more NR messages that cannot perform CRS rate matching.

If in step 1009, the LTE scheduler 603 determines that information is available relating to the one or more resources to be used by the NR base station to transmit the one or more NR messages that cannot perform CRS rate matching, the method passes to step 1010 in which the LTE scheduler determines to mute the one or more resources.

If in step 1009, the LTE scheduler 603 determines that no information is available relating to resources to be used by the NR base station to transmit the one or more NR messages that cannot perform CRS rate matching, the method passes to step 1011 in which the LTE scheduler 603 determines to mute the resources allocated to the NR base station (e.g. all resources not allocated to the LTE base station).

In step 1012, the LTE scheduler 603 transmits the muting determined to the LTE DL transmitter which then mutes the appropriate resources in step 1013.

In some examples, the LTE scheduler 603 may instruct the LTE DL transmitter to apply additional power on non-interfering CRS REs which was saved by not transmitting power on the interfering CRS RE.

The resource allocation decision to the NR base station in step 1006 may indicate to NR that it can transmit non-CRS rate matching messages without considering LTE interference.

In step 1014, the NR scheduler 601 performs normal link adaptation and indicates in step 1015 to NR DL transmitter to transmit regular NR transmissions. IT will be appreciated that steps 1014 and 1015 may be performed in parallel with steps 1007 to 1013.

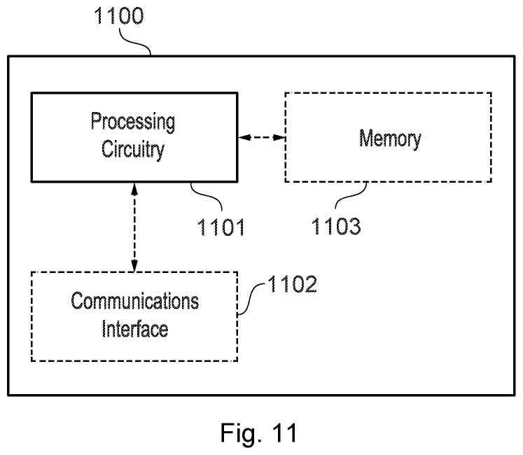

FIG. 11 illustrates a first scheduler 1100 comprising processing circuitry (or logic) 1101. The processing circuitry 1101 controls the operation of the first scheduler 1100 and can implement the method described herein in relation to a first scheduler 1100 or an NR scheduler 601. The processing circuitry 1101 can comprise one or more processors, processing units, multi-core processors or modules that are configured or programmed to control the first scheduler 1100 in the manner described herein. In particular implementations, the processing circuitry 1101 can comprise a plurality of software and/or hardware modules that are each configured to perform, or are for performing, individual or multiple steps of the method described herein in relation to the first scheduler 1100.

Briefly, the processing circuitry 1101 of the first scheduler 1100 is configured to: determine that one or more NR messages are to be scheduled for transmission during a time period, wherein the one or more NR messages cannot perform LTE Cell Specific Reference Signal, CRS, rate matching; and responsive to the determination, transmit a first indication that there are one or more NR messages that cannot perform LTE CRS rate matching to be transmitted during the time period to a shared resource allocator configured to allocate resources to the NR base station and the LTE base station.

In some embodiments, the first scheduler 1100 may optionally comprise a communications interface 1102. The communications interface 1102 of the first scheduler 1100 can be for use in communicating with other nodes, such as other virtual nodes. For example, the communications interface 1102 of the first scheduler 1100 can be configured to transmit to and/or receive from other nodes requests, resources, information, data, signals, or similar. The processing circuitry 1101 of first scheduler 1100 may be configured to control the communications interface 1102 of the first scheduler 1100 to transmit to and/or receive from other nodes requests, resources, information, data, signals, or similar.

Optionally, the first scheduler 1100 may comprise a memory 1103. In some embodiments, the memory 1103 of the first scheduler 1100 can be configured to store program code that can be executed by the processing circuitry 1101 of the first scheduler 1100 to perform the method described herein in relation to the first scheduler 1100. Alternatively, or in addition, the memory 1103 of the first scheduler 1100, can be configured to store any requests, resources, information, data, signals, or similar that are described herein. The processing circuitry 1101 of the first scheduler 1100 may be configured to control the memory 1103 of the first scheduler 1100 to store any requests, resources, information, data, signals, or similar that are described herein.

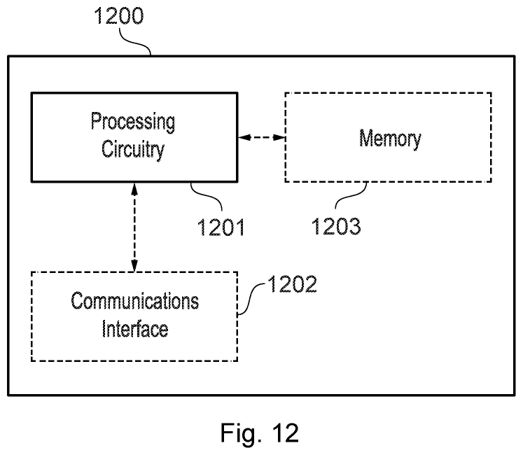

FIG. 12 illustrates a second scheduler 1200 comprising processing circuitry (or logic) 1201. The processing circuitry 1201 controls the operation of the second scheduler 1200 and can implement the method described herein in relation to a second scheduler 1200 or an LTE scheduler 603. The processing circuitry 1201 can comprise one or more processors, processing units, multi-core processors or modules that are configured or programmed to control the second scheduler 1200 in the manner described herein. In particular implementations, the processing circuitry 1201 can comprise a plurality of software and/or hardware modules that are each configured to perform, or are for performing, individual or multiple steps of the method described herein in relation to the second scheduler 1200.

Briefly, the processing circuitry 1201 of the second scheduler 1200 is configured to: receive a first indication that there are one or more NR messages to be transmitted by the NR base station during a time period that cannot perform LTE Cell Specific Reference Signal, CRS, rate matching; and responsive to receiving the indication, instruct a DL transmitter in the LTE base station to mute CRS on one or more resources during the time period.

In some embodiments, the second scheduler 1200 may optionally comprise a communications interface 1202. The communications interface 1202 of the second scheduler 1200 can be for use in communicating with other nodes, such as other virtual nodes. For example, the communications interface 1202 of the second scheduler 1200 can be configured to transmit to and/or receive from other nodes requests, resources, information, data, signals, or similar. The processing circuitry 1201 of second scheduler 1200 may be configured to control the communications interface 1202 of the second scheduler 1200 to transmit to and/or receive from other nodes requests, resources, information, data, signals, or similar.

Optionally, the second scheduler 1200 may comprise a memory 1203. In some embodiments, the memory 1203 of the second scheduler 1200 can be configured to store program code that can be executed by the processing circuitry 1201 of the second scheduler 1200 to perform the method described herein in relation to the second scheduler 1200. Alternatively, or in addition, the memory 1203 of the second scheduler 1200, can be configured to store any requests, resources, information, data, signals, or similar that are described herein. The processing circuitry 1201 of the second scheduler 1200 may be configured to control the memory 1203 of the second scheduler 1200 to store any requests, resources, information, data, signals, or similar that are described herein.

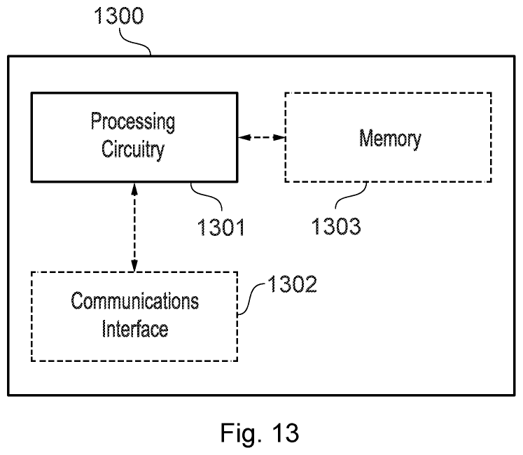

FIG. 13 illustrates a shared resource allocator 1300 comprising processing circuitry (or logic) 1301. The processing circuitry 1301 controls the operation of the shared resource allocator 1300 and can implement the method described herein in relation to a shared resource allocator 1300 or 605. The processing circuitry 1301 can comprise one or more processors, processing units, multi-core processors or modules that are configured or programmed to control the shared resource allocator 1300 in the manner described herein. In particular implementations, the processing circuitry 1301 can comprise a plurality of software and/or hardware modules that are each configured to perform, or are for performing, individual or multiple steps of the method described herein in relation to the shared resource allocator 1300.

Briefly, the processing circuitry 1301 of the shared resource allocator 1300 is configured to: receive a first indication, from the NR base station, that one or more NR messages to be scheduled for transmission during a time period cannot perform LTE CRS rate matching; and responsive to receiving the first indication from the NR base station, transmit a second indication, to the LTE base station, that there are one or more NR messages to be scheduled for transmission during the time period that cannot perform LTE CRS rate matching.

In some embodiments, the shared resource allocator 1300 may optionally comprise a communications interface 1302. The communications interface 1302 of the shared resource allocator 1300 can be for use in communicating with other nodes, such as other virtual nodes. For example, the communications interface 1302 of the shared resource allocator 1300 can be configured to transmit to and/or receive from other nodes requests, resources, information, data, signals, or similar. The processing circuitry 1301 of shared resource allocator 1300 may be configured to control the communications interface 1302 of the shared resource allocator 1300 to transmit to and/or receive from other nodes requests, resources, information, data, signals, or similar.

Optionally, the shared resource allocator 1300 may comprise a memory 1303. In some embodiments, the memory 1303 of the shared resource allocator 1300 can be configured to store program code that can be executed by the processing circuitry 1301 of the shared resource allocator 1300 to perform the method described herein in relation to the shared resource allocator 1300. Alternatively, or in addition, the memory 1303 of the shared resource allocator 1300, can be configured to store any requests, resources, information, data, signals, or similar that are described herein. The processing circuitry 1301 of the shared resource allocator 1300 may be configured to control the memory 1303 of the shared resource allocator 1300 to store any requests, resources, information, data, signals, or similar that are described herein.

Embodiments described herein reduce interference for non-CRS rate matching NR messages when spectrum sharing is used. This may result in better decoding performance of the non-CRS rate matching NR messages. Some embodiments may also result is less use of PRB for non-CRS rate matching NR messages. Some embodiments may also provide improved NR accessibility in spectrum sharing.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method in first scheduler for use in a New Radio base station that is spectrum sharing with a Long Term Evolution, LTE, base station, the method comprising:
determining that one or more NR messages are to be scheduled for transmission during a time period, the one or more NR messages cannot perform LTE Cell Specific Reference Signal, CRS, rate matching; and
responsive to the determination, transmitting a first indication that there are one or more NR messages that cannot perform LTE CRS rate matching to be transmitted during the time period to a shared resource allocator configured to allocate resources to the NR base station and the LTE base station.

2. The method as claimed in claim 1, wherein the time period comprises a transmission time interval.

3. The method as claimed in claim 1, further comprising:
receiving a second indication of one or more resources to be used by the NR base station to transmit the one or more NR messages; and
transmitting the one or more NR messages using the one or more resources.

4. The method as claimed in claim 3, wherein the one or more resources comprises:
one or both of:
one or more of Physical Downlink Control Channel; and
Physical Downlink Shared Channel physical resource blocks; or
resource block groups.

5. The method as claimed in claim 1, wherein the one or more NR messages comprises one or more of: a message to be transmitted during a random access procedure, a paging message and a message to be transmitted whilst a wireless device is in an idle state.

6. The method as claimed in claim 1, wherein the first indication is for use in the LTE base station to mute CRS on one or more resources during the time period.

7. A method in a second scheduler for use in a Long Term Evolution base station that is spectrum sharing with a New Radio, NR, base station, the method comprising:
receiving a first indication that there are one or more NR messages to be transmitted by the NR base station during a time period that cannot perform LTE Cell Specific Reference Signal, CRS, rate matching; and
responsive to receiving the indication, instructing a DL transmitter in the LTE base station to mute CRS on one or more resources during the time period.

8. (canceled)

9. The method as claimed in claim 72 further comprising: wherein the one or more resources comprise one or more resources allocated to the one or more messages, and wherein the method further comprises:
receiving a second indication of the one or more resources.

10. The method as claimed in claim 7, further comprising instructing the DL transmitting in the LTE base station to boost power on transmission of one or more other CRSs transmitted during the time interval.

11. (canceled)

12. The method as claimed in claim 7, wherein the one or more NR messages comprise one or more of: a message to be transmitted during a random access procedure, a paging message and a message to be transmitted whilst a wireless device is in an idle state.

13. A method in a shared resource allocator configured to allocate shared resources to a Long Term Evolution base station and a New Radio, NR, base station that are spectrum sharing, the method comprising:
receiving a first indication, from the NR base station, that one or more NR messages to be scheduled for transmission during a time period cannot perform LTE CRS rate matching; and
responsive to receiving the first indication from the NR base station, transmitting a second indication, to the LTE base station, that there are one or more NR messages to be scheduled for transmission during the time period that cannot perform LTE CRS rate matching.

14. The method as claimed in claim 132 wherein the time period comprises a transmission time interval.

15. The method as claimed in claim 13, further comprising transmitting a third indication of one or more resources to be used by the NR base station to transmit the one or more NR messages

16. The method as claimed in claim 15, wherein the one or more resources comprises one or more of PDCCH/PDSCH physical resource blocks or resource block groups.

17. The method as claimed in claim 15, further comprising transmitting, to the LTE base station, the third indication of the one or more resources to be used by the NR base station to transmit the one or more NR messages.

18. The method as claimed in claim 13, wherein the one or more NR messages comprises one or more of: a message to be transmitted during a random access procedure, a paging message and a message to be transmitted whilst a wireless device is in an idle state.

19. A first scheduler for use in a New Radio base station that is spectrum sharing with a Long Term Evolution, LTE, base station, the first scheduler comprising processing circuitry configured to:
determine that one or more NR messages are to be scheduled for transmission during a time period, the one or more NR messages cannot perform LTE Cell Specific Reference Signal, CRS, rate matching; and
responsive to the determination, transmit a first indication that there are one or more NR messages that cannot perform LTE CRS rate matching to be transmitted during the time period to a shared resource allocator configured to allocate resources to the NR base station and the LTE base station.

20. The first scheduler as claimed in claim 19, wherein the time period comprises a transmission time interval.

21. A second scheduler for use in a Long Term Evolution base station that is spectrum sharing with a New Radio, NR, base station, the second scheduler comprising processing circuitry configured to:
receive a first indication that there are one or more NR messages to be transmitted by the NR base station during a time period that cannot perform LTE Cell Specific Reference Signal, CRS, rate matching; and
responsive to receiving the indication, instruct a DL transmitter in the LTE base station to mute CRS on one or more resources during the time period.

22. (canceled)

23. A shared resource allocator configured to allocate shared resources to a Long Term Evolution base station and a New Radio, NR, base station that are spectrum sharing, the shared resource allocator comprising processing circuitry configured to:
receive a first indication, from the NR base station, that one or more NR messages to be scheduled for transmission during a time period cannot perform LTE CRS rate matching; and
responsive to receiving the first indication from the NR base station, transmit a second indication, to the LTE base station, that there are one or more NR messages to be scheduled for transmission during the time period that cannot perform LTE CRS rate matching.

24.-26. (canceled)
